(19) United States
(12) Patent Application Publication
(10) Pub. No.: US 2014/0138359 A1
(43) Pub. Date: May 22, 2014

(54) METHOD AND SYSTEM FOR DAMAGE REDUCTION IN OPTICS USING SHORT PULSE PRE-EXPOSURE

(71) Applicant: LAWRENCE LIVERMORE NATIONAL SECURITY, LLC, Livermore, CA (US)

(72) Inventors: Christopher Wren Carr, Livermore, CA (US); Raluca A. Negres, Pleasanton, CA (US); Mary A. Norton, Livermore, CA (US); David A. Cross, Livermore, CA (US)

(73) Assignee: LAWRENCE LIVERMORE NATIONAL SECURITY, LLC, Livermore, CA (US)

(21) Appl. No.: 13/682,239

(22) Filed: Nov. 20, 2012

(51) Int. Cl. B23K 26/00; B23K 26/08

(52) U.S. Cl. CPC B23K 26/0066; B23K 26/0869
USPC 219/121.8; 219/121.83

(57) ABSTRACT

A method of processing an optical element includes providing the optical element. A surface region of the optical element includes one or more pre-cursors. The method also includes raster scanning a laser beam across the optical element. The laser beam comprises a plurality of laser pulses, each of the laser pulses being characterized by a pulse length less than 1 ns. The method further includes exposing the one or more pre-cursors to the laser beam and observing a light emission event from one of the one or more pre-cursors.

### STATEMENT AS TO RIGHTS TO INVENTIONS MADE UNDER FEDERALLY SPONSORED RESEARCH OR DEVELOPMENT

The United States Government has rights in this invention pursuant to Contract No. DE-AC52-07NA27344 between the U.S. Department of Energy and Lawrence Livermore National Security, LLC, for the operation of Lawrence Livermore National Laboratory.

### BACKGROUND OF THE INVENTION

Projections by the Energy Information Agency and current Intergovernmental Panel on Climate Change (IPCC) scenarios expect worldwide electric power demand to double from its current level of about 2 terawatts electrical power (TWe) to 4 TWe by 2030, and could reach 8-10 TWe by 2100. They also expect that for the next 30 to 50 years, the bulk of the demand of electricity production will be provided by fossil fuels, typically coal and natural gas. Coal supplies 41% of the world's electric energy today, and is expected to supply 45% by 2030. In addition, the most recent report from the IPCC has placed the likelihood that man-made sources of CO₂ emissions into the atmosphere are having a significant effect on the climate of planet earth at 90%. “Business as usual” baseline scenarios show that CO₂ emissions could be almost two and a half times the current level by 2050. More than ever before, new technologies and alternative sources of energy are essential to meet the increasing energy demand in both the developed and the developing worlds, while attempting to stabilize and reduce the concentration of CO₂ in the atmosphere and mitigate the concomitant climate change.

Nuclear energy, a non-carbon emitting energy source, has been a key component of the world's energy production since the 1950's, and currently accounts for about 16% of the world's electricity production, a fraction that could—in principle—be increased. Several factors, however, make its long-term sustainability difficult. These concerns include the risk of proliferation of nuclear materials and technologies resulting from the nuclear fuel cycle; the generation of long-lived radioactive nuclear waste requiring burial in deep geological repositories; the current reliance on the once through, open nuclear fuel cycle; and the availability of low cost, low carbon footprint uranium ore. In the United States alone, nuclear reactors have already generated more than 55,000 metric tons (MT) of spent nuclear fuel (SNF). In the near future, we will have enough spent nuclear fuel to fill the Yucca Mountain geological waste repository to its legislated limit of 70,000 MT.

Fusion is an attractive energy option for future power generation, with two main approaches to fusion power plants now being developed. In a first approach, Inertial Confinement Fusion (ICF) uses lasers, heavy ion beams, or pulsed power to rapidly compress capsules containing a mixture of deuterium (D) and tritium (T). As the capsule radius decreases and the DT gas density and temperature increase, DT fusion reactions are initiated in a small spot in the center of the compressed capsule. These DT fusion reactions generate both alpha particles and 14.1 MeV neutrons. A fusion burn front propagates from the spot, generating significant energy gain. A second approach, magnetic fusion energy (MFE) uses powerful magnetic fields to confine a DT plasma and to generate the conditions required to sustain a burning plasma and generate energy gain.

Important technology for ICF is being developed primarily at the National Ignition Facility (NIF) at Lawrence Livermore National Laboratory (LLNL), assignee of this invention, in Livermore, Calif. There, a laser-based ICF project designed to achieve thermonuclear fusion ignition and burn utilizes laser energies of 1 to 2 MJ. Fusion yields of the order of 10 to 20 MJ are expected. Fusion yields in excess of 200 MJ are expected to be required in a central hot spot fusion geometry if fusion technology, by itself, were to be used for cost effective power generation. Thus, significant technical challenges remain to achieve an economy powered by pure ICF energy.

In addition to ICF applications, there is broad interest in the area of high average power lasers for materials processing, drilling, cutting and welding, military applications, and the like. In the past a number of efforts have been made to regulate laser induced damage on SiO₂ optics by pre-initiating damage and then repairing it as a final processing step before the optics are used. This method has the advantage of allowing weak locations on an optic to self identify by initiation under controlled circumstances. Because the process is done before installation, weak locations on an optic can be repaired after a single initiation pulse, rather than after being initiated and grown for some number of shots as would likely be the case if the damage were to initiate after installation.

Laser-induced damage on both surfaces, but especially the exit surface of fused silica optics is a topic of considerable interest for large aperture, high-power laser systems such as the NIF and the Laser MegaJoule (LMJ). Laser damage can be discussed in terms of two key problems: damage initiation by a single pulse and damage growth due to subsequent laser pulses. Despite the progress made in understanding damage processes, there is a need in the art for improved methods and systems for mitigating the growth of laser damage sites on optical elements.

### SUMMARY OF THE INVENTION

According to the present invention, techniques related to optical systems are provided. More particularly, embodiments of the present invention provide methods and systems for mitigating the growth of damage sites on optical elements. Merely by way of example, the methods and systems described herein have been applied to the conditioning of small sites (e.g., less than 20 in μm in size) using short pulses (e.g., less than 1 ns in duration). Embodiments of the present invention are applicable to a variety of optical materials including fused silica optics.

The inventors have determined that the growth of laser damage on optical elements (e.g., fused silica optical components) depends on several parameters including laser fluence, wavelength, pulse duration, and site size. The inventors have studied the growth behavior of small damage sites on the exit surface of SiO₂ optics under exposure to tightly controlled laser pulses. The results demonstrate that the onset of damage growth is not governed by a threshold, but is probabilistic in nature and depends both on the current size of a damage site and the laser fluence to which it is exposed. Additionally, it is demonstrated that laser exposure history also influences the behavior of individual sites.

According to embodiments of the present invention, the growth of damage sites on optical components (e.g., SiO₂-based optics) used in high power lasers is reduced or eliminated by pre-exposure to pulses of a few hundred picoseconds in duration. Such pre-exposure causes weak locations on the optics surface to self-identify by initiating very small damage sites. In some embodiments, the sites that initiate will be only a few microns in diameter and will have a very low probability of growing even without any further treatment. It has been demonstrated that both laser mitigation and acid etching have a near perfect ability to prevent such small sites from growing.

As described herein, measurements of the probability of the formation of a damage site as a function of pre-cursor site size demonstrate that the smaller the site, the smaller the likelihood of growth on a given shot. This observation and the size dependence of initiation size on pulse duration enables the ability to initiate damage sites small enough that they will be un-likely to grow. Pulses as short as a few tens of picoseconds (or shorter) are used to produce sites as small as a micron or less in size. It should be noted that a one micron site is expected to have a probability of growth of ˜10⁻⁶.

Currently both the National Ignition Facility (NIF) and the Laser Mega Joule pre-treat large SiO₂ optics used in their systems with various methods to enhance the working lifetime of the optics. As an example, NIF currently uses only an acid mitigation technique that effectively reduces damage, but degrades the surface figure of the optic. Laser Mega Joule currently uses a long pulse laser to pre-initiate their optics. Sites created by the long pulse laser (i.e., a XeF laser) produce damage sites about 50 times larger than those produced by the methods described herein. The sites produced by a XeF tend to grow if exposed to subsequent laser energy and are extremely difficult to repair by etching or laser melting or ablation while small sites are easier to repair and may not tend to grow, even without repair.

As described herein, the inventors have demonstrated that initiation with short pulses produces sites ˜50 times smaller than sites initiated by the pre-initiation method discussed above (i.e., XeF laser pre-initiation). Additionally, the inventors have determined that both acid and laser mitigation techniques are more suitable for rendering small sites inert (i.e., preventing them from growing). Consequently, using short pulse initiation prior to laser or chemical mitigation is a technique useful for making more robust optics. Moreover, etching small sites produces much less undulations in the input surface then laser or acid mitigation, which in turn produces much less downstream modulation of the beam. Moreover, because small sites have a small probability of growth, if sites are initiated at a small enough size, no further treatment may be necessary for the optical component.

The inventors have determined that the onset of damage growth is not governed by a threshold, but is probabilistic in nature and depends both on the current size of a damage site and the laser fluence to which it is exposed. Furthermore, the history of laser exposure also influences the behavior of individual sites. This taken with the shot to shot independence to the probability of growth clearly indicates that internal features of the damage sites evolve with each laser exposure even if such changes do not manifest as observable changes to the site diameter. Embodiments of the present invention are applicable to the development of predictive models on laser damage evolution from initiation to a preset size imposed by various damage repair protocols. Thus, embodiments of the present invention can be used to post-process optics in order to make them more robust.

According to an embodiment of the present invention, a method of processing an optical element is provided. The method includes providing the optical element. A surface region of the optical element includes one or more pre-cursors. The method also includes raster scanning a laser beam across the optical element. The laser beam comprises a plurality of laser pulses, each of the laser pulses being characterized by a pulse length less than 1 ns. The method further includes exposing the one or more pre-cursors to the laser beam and observing a light emission event from one of the one or more pre-cursors.

According to an embodiment of the present invention, a system for processing an optical element is provided. The system includes a stage operable to support the optical element. A surface region of the optical element includes one or more pre-cursors. The system also includes a picosecond laser operable to provide a laser beam including a plurality of laser pulses. Each of the laser pulses is characterized by a pulse length less than 1 ns. The system further comprises a control system coupled to at least one of the stage or the picosecond laser and operable to raster scan the laser beam across the optical element and an optical detector operable to observe a light emission event from one of the one or more pre-cursors.

Numerous benefits are achieved by way of the present invention over conventional techniques. For example, embodiments of the present invention provide methods and systems in which less surface area of the optical element is modified that in conventional techniques, resulting in smaller damage sites and, thereby, smaller mitigation sites. These benefits enable the optical elements to be exposed to higher fluence at which the number of initiations are no longer small. As an example, using the methods and systems described herein, ˜1000 times more sites can be accommodated on an optical element with the same global beam quality degradation as associated with conventional techniques. Additionally, small sites are faster to repair with laser techniques (e.g., requiring less manpower) and requiring less powerful lasers (e.g., requiring lower equipment cost) to affect the repair.

Moreover, for a given repair technique, the repair of smaller sites has a much higher success rate and causes less downstream modulation (i.e., less local degradation of beam quality), which reduces the constraints of where adjacent optics can be located. It should be noted that acid etching is not typically an option with XeF initiated sites since they are too large and a significant fraction will continue to grow (i.e., repair and/or mitigation will likely fail). As described herein the sites may be initiated at a small enough size so that no further mitigation is necessary. Additionally, the techniques described herein are suitable for in situ pre-initiation. With a pulse shape agile laser, such as NIF, weak spots on the optical element can be initiated after instillation. If a sufficiently short pulse is used, the pre-initiation sites will be small enough that they will not grow. Embodiments of the present invention are applicable to mirrors, both during manufacture (i.e., off-line) or after installation in a system with a pulse shape agile laser. Additionally, embodiments of the present invention are also applicable to mitigation of surface damage on crystals. These and other embodiments of the invention along with many of its advantages and features are described in more detail in conjunction with the text below and attached figures.

### BRIEF DESCRIPTION OF THE DRAWINGS

FIG. 1A is a representative layout of damage sites and in-beam CO₂ fiducials according to an embodiment of the present invention.

FIG. 1B is a histogram of size distribution of individual pits produced by laser initiation method according to an embodiment of the present invention;

FIG. 2A is a micrograph of small damage sites acquired by a robotic microscope using back illumination before laser exposure according to an embodiment of the present invention;

FIG. 2B is a micrograph of small damage sites acquired by a robotic microscope using back illumination after one laser exposure according to an embodiment of the present invention;

FIG. 2C is a table listing the binary growth decisions based on visual inspection compared to the measured changes in the sites' diameter according to an embodiment of the present invention;

FIG. 3 is a plot illustrating the single-shot probability of growth vs. size vs. shot number according to an embodiment of the present invention;

FIG. 4A is a plot illustrating cumulative single-shot probability of growth vs. site size vs. laser fluence for damage sites according to an embodiment of the present invention;

FIG. 4B is a plot illustrating cumulative single-shot probability of growth vs. site size vs. laser fluence for damage sites according to another embodiment of the present invention;

FIG. 5A is a plot illustrating a comparison of the probability of growth vs. fluence for 20-30 μm and 30-50 μm size bins according to an embodiment of the present invention;

FIG. 5B is a plot illustrating a comparison of the fluence at which the probability of growth is equal to 0.5, x₀, vs. damage site size (bin center) for two laser exposure scenarios according to an embodiment of the present invention;

FIG. 6 is a simplified flowchart illustrating a method of processing an optical element according to an embodiment of the present invention; and

FIG. 7 is a simplified schematic diagram of a system for processing optical elements according to an embodiment of the present invention.

### DETAILED DESCRIPTION OF THE INVENTION

According to the present invention, techniques related to optical systems are provided. More particularly, embodiments of the present invention provide methods and systems for mitigating the growth of damage sites on optical elements. Merely by way of example, the methods and systems described herein have been applied to the conditioning of small sites (e.g., less than 20 in μm in size) using short pulses (e.g., less than 1 ns in duration). Embodiments of the present invention are applicable to a variety of optical materials including fused silica optics.

Past work has relied on XeF lasers because of their excellent beam and reliability characteristics. The disadvantage to using a XeF laser is that the pulse shape has an effective temporal duration much longer than the pulses used on fusion class laser systems requiring higher fluence and producing larger damage sites, as discussed below. As previously mentioned, the long pulse duration of the XeF system is extremely detrimental in two ways. The first way in which the use of a XeF laser for pre-initiation is detrimental is that higher fluence must be used in order to prepare an optic. As local hot spots can move from location to location, an optic often needs to be resistant to damage from fluences significantly above the beam average. The size of damage sites increases with increased fluence. XeF lasers are also detrimental because their effective pulse duration is much longer than the pulses typically used on fusion class laser systems. This feature also increases the initiation size of damage sites. The two effects combine to make sites so large that they will most probably grow under laser illumination. In addition, the smaller a site is, the higher probability that it will be successfully repaired. As a result, large sites are very difficult and more costly if not impossible to repair.

In recent years, advances in the manufacturing and post-processing steps have lead to significant improvements in the surface quality of fused silica components and thus a notable reduction in the number of initiations per optic. The size of damage initiation sites created by nanosecond (ns) pulses is strongly influenced by the pulse duration, shape, and fluence but ranges from less than 1 μm to 30 μm. The overall site morphology, including modified material, stresses and fractures, plays an important role in the future evolution of such a site under subsequent laser exposure. In general terms, the damage process is likely to re-ignite at the damage site location, causing an expansion of the damaged volume, referred to as damage growth. Specifically, small sites (with diameters less than ˜50 μm) grow, in general, in response to a higher laser fluence and their behavior is better described by a probability of growth. As described herein, the growth probability of laser induced damage sites on the exit surface of SiO₂ optics are analyzed under exposure to carefully controlled and characterized laser pulses. Descriptive statistics are used to summarize the evolution of a large ensemble of sites. This method allows quantification of the effects of site size and laser fluence on the probability of growth from data sets collected at fixed pulse durations.

Damage tests with 1-cm diameter beams show that the fluence needed to produce a density of 1 site per square mm with a XeF laser is between 25 and 30 J/cm² where, a typical pulse shape used for ignition experiments will produce the same damage density at fluences between 15 J/cm² and 20 J/cm².

Our experimental approach to growth studies can be summarized as follows: The advantage provided by the 3-cm diameter Optical Science Laboratory (OSL) laser beam was used to simultaneously test a large number of sites with local fluences that vary within ±2-3 J/cm² (due to the ˜17% spatial beam contrast) around the beam average fluence. For each site, the local mean fluence was computed in a ˜0.5 mm patch with 10% uncertainty using the fluence registration method. Individual site diameters are measured after each laser shot using a robotic microscope under various illuminations (back- and oblique incidence-light resulting in bright and dark field images, respectively) with optical resolution as high as 0.86 μm. This highly parallel technique greatly enhances data collection rate while maintaining precision not typically available in-situ. The description below focuses on sites exposed on the exit surface of SiO₂ samples in high-vacuum with 351-nm, 5-ns Flat-In-Time (FIT) pulses.

According to an embodiment, an unknown parameter (i.e., probability of growth) is estimated from a limited number of observations. Thus, in these embodiments, it is important to consider the limitations on accuracy imposed by the sample sizes. The percent error on a probability measurement based on the number of observations, n, can be estimated from:

$$\% error = \frac{p ( 1 - p )}{p \sqrt{n}} , \qquad ( 1 )$$

where p is the expected probability value. In other words, if probability of an outcome is low, a larger number of observations are needed to maintain a given uncertainty. As a rule of thumb, a minimum of 50 samples is required to maintain uncertainty of less than 15% for events with a likelihood of ˜5% or more.

For the above reasons, embodiments of the present invention use a raster scan initiation method to prepare a large number of damage sites with sizes in the ˜10-80 μm range on a single substrate to be tested simultaneously. These sites were initiated in a regular array with nominal spacing of 1 mm with a single pulse from a 355-nm, Nd:YAG table top laser with an 8-ns near Gaussian temporal profile focused to a spatial Gaussian spot of ˜450 μm (diameter at 1/e² of intensity) on the exit surface of a 1-cm thick silica substrate (e.g., Corning 7980 glass).

The laser fluence was tailored to a level such that the single-shot (S/1) probability to initiate damage at any given location did not exceed 30%. For a bare silica substrates prepared with high damage resistance surfaces, this lower fluence corresponds to 40-45 J/cm² while a fluence of 60-70 J/cm² was necessary for 100% initiation probability under similar focusing conditions (peak fluence values are quoted here). There are several benefits of using a raster approach in combination with lower initiation fluence. Not only are many more small sites generated on a given sample compared to past sample preparations, but the size distribution (and the overall damage morphology) produced by this method is very similar to that observed from large beam initiation, i.e., mostly single pit damage sites with diameters up to ˜40 μm.

However, due to inherent shot-to-shot laser fluence fluctuations and/or non-uniformities in the substrate surface, a small number of larger (up to 80 μm) and/or multi-pit sites were also initiated. We thus ensure that the sites are representative of those encountered in high power, large aperture laser systems and the results of this work are applicable to the development of predictive models on laser damage evolution within such systems. The sample was translated in a raster scan pattern and a single laser pulse was fired at each of ˜900 locations from a preset grid with 1 mm spacing, resulting in ˜300 initiated sites within the 3-cm OSL beam aperture. If a higher throughput of initiation sites is desired, while preserving the site morphologies, a sample could be scanned twice using interleaved grids, i.e., minimum site separation of 0.5 mm. The combination of a preset grid and a small focused beam used for initiation minimizes the cross talk between adjacent damage sites with diameters up to about ˜500 μm, which is not a significant limitation considering that only a small fraction of these small sites will grow at fluences up to about 12 J/cm².

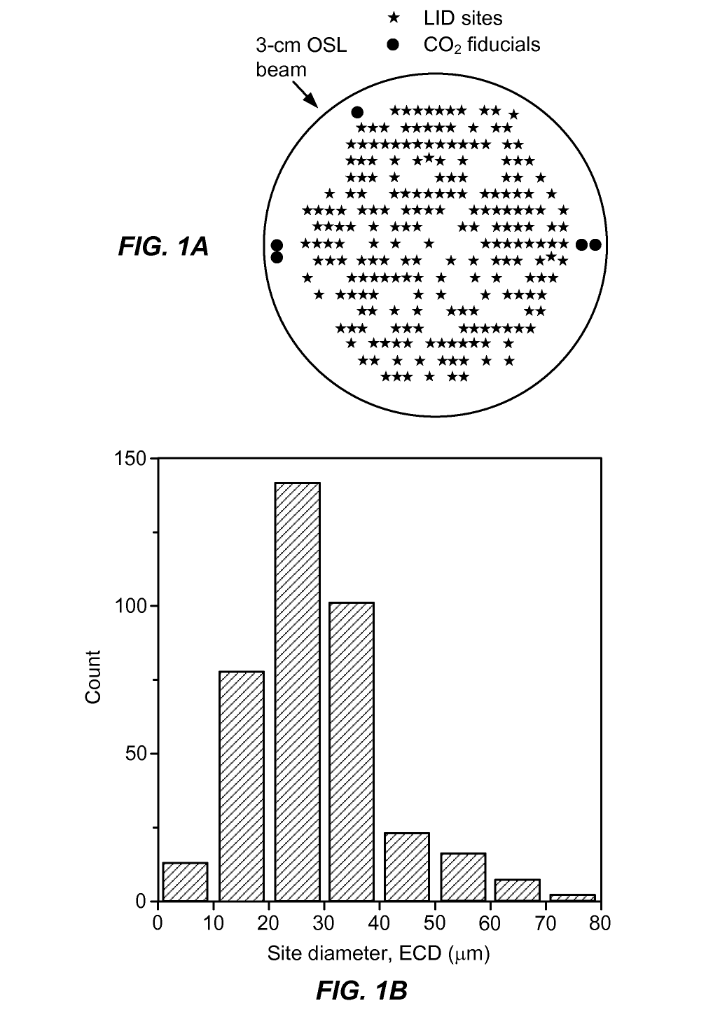

A typical damage site initiation layout as well as the size distribution of individual pits prepared by the raster-scan method (one pass) outlined above are illustrated in FIGS. 1A-1B, respectively. In this case, damage initiation occurred at 220 locations within the 3-cm OSL beam aperture centered on a 2-inch silica substrate. As damage sites typically have aspect ratio close to one, but are not circular, it is possible to describe their diameter in terms of an effective circular diameter, ECD, defined as 2\sqrt{A/90}, where A is the area of the site. The site diameters ranged from ˜7 μm up to ˜80 μm. Three samples were prepared in a similar fashion and sites were characterized using the robotic microscope.

FIG. 1A is a typical layout of damage sites and in-beam CO₂ fiducials. FIG. 1B is a plot of size distribution of individual pits produced by a single pass, raster scan initiation method at a preset grid with 1 mm spacing on the exit surface of SiO₂ substrates during experiments to characterize the probability of growth.

Based on the OSL beam contrast, it is possible to design probability of growth experiments at fixed fluences to cover the range of 4-12 J/cm² (in high-vacuum, 351-nm, 5-ns FIT pulses). Specifically, three samples were prepared with up to 300 small damage sites per sample using the raster scan method outlined above and exposed for 4-5 shots at 5 J/cm², 8.5 J/cm², and 10.5 J/cm² nominal fluences, respectively. Furthermore, in order to study the effects of laser exposure history, the fluence on one of the samples (#1) was ramped from low to high using small fluence increments (5, 6 J/cm², 8.5 J/cm², and 10.5 J/cm² with 4, 5, 2, and 2 shots at each fluence step, respectively).

Upon completion of the shot sequences and the acquisition of micrographs for individual sites on a given sample, the data was reduced as follows. The pre- and post-shot micrographs of individual sites are compared and a binary growth decision is made, either 1 or 0 if the lateral dimensions of the sites, including sub-surface fracture, did or did not change following the laser shot, respectively. In some implementations, this growth classification is made by a human, whereas in other implementations, it is based on an image thresholding routine. One of ordinary skill in the art would recognize many variations, modifications, and alternatives. It should be noted that although human evaluation can be labor intensive, it enables the virtual elimination of experimental errors (including instrument and image processing) in the detection of growth.

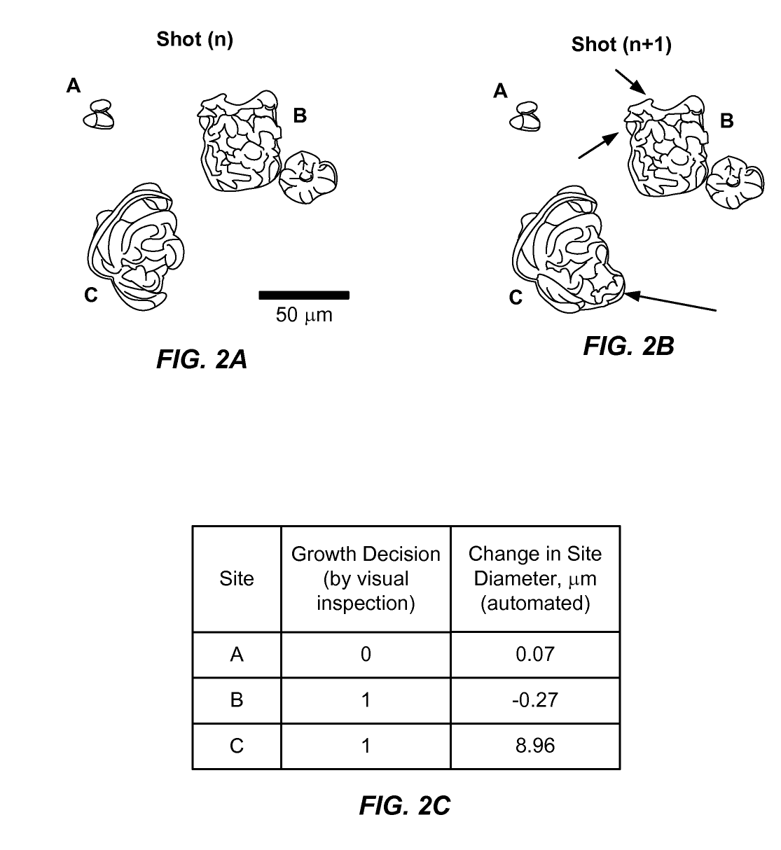

The growth classification procedure after one laser exposure is illustrated in FIGS. 2A and 2B for three damage sites (A, B, and C). FIG. 2A is a micrograph of small damage sites acquired by a robotic microscope using back illumination before laser exposure. FIG. 2B is a micrograph of small damage sites acquired by a robotic microscope using back illumination after one laser exposure. It should be noted that both images are on the same scale. The arrows in FIG. 2B indicate the locations where changes in the sites' lateral dimensions occurred after laser exposure. FIG. 2C is a table listing the binary growth decisions based on visual inspection compared to the measured changes in the sites' diameter.

Referring to FIGS. 2A-2C, it should be noted that inspection of the pre- and post-shot micrographs of these sites revealed no changes in the lateral dimensions of site A. In contrast, minor changes (limited to 1-2 pixels) at the periphery of site B and a relatively large change for site C occurred, as indicated by the arrows in FIG. 2B. Therefore, the binary growth decision corresponding to sites A, B, and C was 0, 1, and 1, respectively, as shown in FIG. 2C. According to embodiments, this exact classification procedure is employed for all sites/shots to detect growth with high confidence. In contrast, detection of growth based on the measured changes in the sites' diameter from shot to shot may yield different results, in particular for small damage sites undergoing minimal or no changes, as illustrated for sites A and B in FIGS. 2A and 2B, respectively. The uncertainty associated with diameter measurements (e.g., automated based on image thresholding routines) is generally about ±2 μm and affects subsequent growth rate calculations. Furthermore, for each laser exposure, damage sites are grouped in several size bins according to their pre-shot measured ECD (e.g., ˜7-20, 20-30, 30-50, 50-70, 70-100, etc.). This grouping allowed the effects of current site size on the probability of growth to be tracked. It should be noted that 10 μm-wide bins were initially employed, however similar growth trends observed from adjacent bins, e.g., 30-40 and 40-50 μm, allowed wider bins to be used with improved statistics (effectively more observations, therefore better accuracy on the probability measurement).

As described below, a preliminary, single-shot probability of growth analysis was performed by computing the fraction of growing sites in each size bin after each shot for a series of laser shots with the same average fluence (not using the local mean fluence for each site yet, i.e., all sites are grouped in one fluence bin). It should be noted that the starting size bin membership of individual sites may or may not be preserved upon subsequent shots depending on their shot-to-shot diameter change.

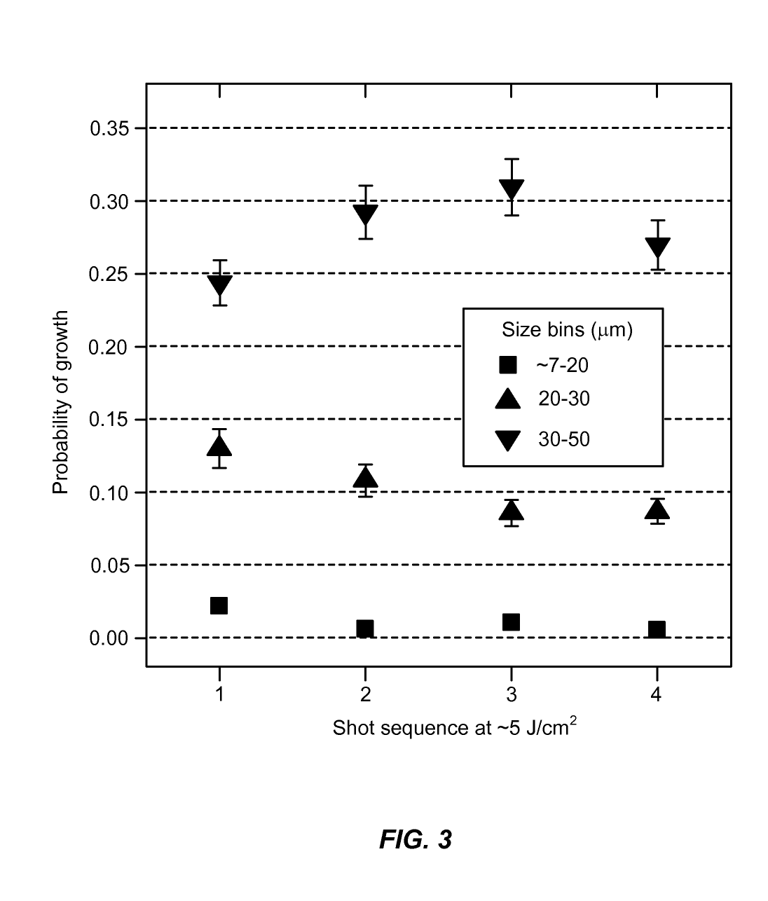

FIG. 3 is a plot illustrating the single-shot probability of growth vs. size vs. shot number obtained for a sample using the first four shots in the test sequence at ˜5 J/cm². The errors bars in FIG. 3 are derived based on Eq. (1) and are estimated at 15%, 10%, and 6% for the ˜7-20, 20-30 and 30-50 μm size bins, respectively. Larger size bins are not shown here for purposes of clarity although the existent data does follow the same general trends. These results confirm that site size is an important parameter in determining the likelihood of a damage site to grow upon laser exposure, i.e., growth probability increases with size. Furthermore, results in FIG. 3 suggest that the probability of growth is reasonably constant shot-to-shot within the frame of this preliminary analysis, namely fluence averaging over the entire beam profile. This behavior was also observed from sites on other samples exposed to series of similar shots at higher laser fluences and has important implications for the fundamental growth mechanisms. Namely, a shot independent probability of growth implies that damage sites are more or less constantly evolving with each laser exposure. This evolution may not necessarily lead to a perceived change in diameter (i.e., lateral dimensions) on every shot, defined as growth herein and detected by examining an optical micrograph with ˜1 μm resolution, but may involve other small internal changes in the site morphology or stress fields surrounding the site. The measurement of such subtle changes can be accomplished using additional diagnostics, such as polarimetry, optical coherence tomography, scanning electron microscopy, and the like.

Herein, we adopt the hypothesis of a shot independent probability of growth for series of nearly identical laser exposures and its direct implications to data analysis. The latter is considerably simplified as we combine all shots as if it were one shot with effectively many more sites exposed at once to their local mean fluence. Indeed, instead of tracking the evolution of a limited number of sites in each size bin from shot to shot, i.e., a single-shot approach that keeps track of shot history and individual sites, we will now group together all observations of sites/shots (corresponding to a size bin) from the tabulated data set associated with an experiment/sample. Each entry (row) in our data set may contain, for example, the site ID, shot number, current site size, previous site size (determines the membership to a size bin for probability measurements), local mean fluence, growth decision (1 or 0), and possibly other attributes (derived or measured parameters) corresponding to one observation of a site on a specific laser shot. The outcome of this analysis is augmented statistics within each size bin that now includes the original sites (as-initiated) and new members (in all but the lowest size bin) as their diameter is changing upon subsequent laser shots. In other words, this cumulative single-shot approach mixes observations of sites with similar size but different laser exposure history (one or more shots at fixed fluences) and provides a first order account of the effects of site size on the probability of growth.

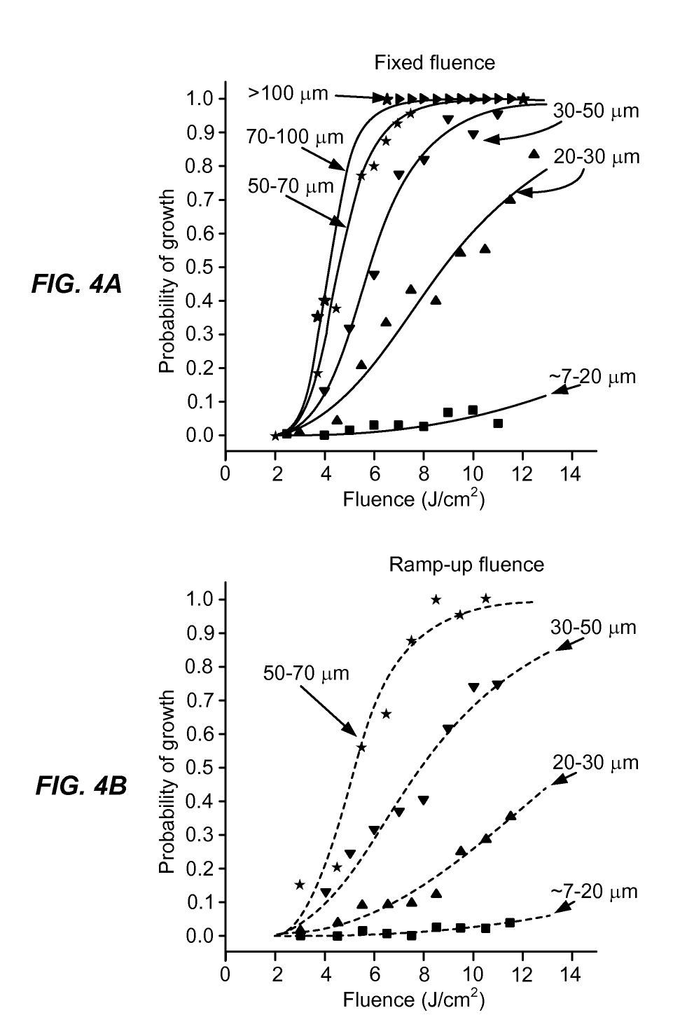

Data analysis was performed for the two experimental scenarios discussed above, namely small damage sites exposed to series of i) nearly constant (at 5 J/cm², 8.5 J/cm², and 10.5 J/cm² from three separate, but similarly prepared samples, respectively) and ii) ramp-up fluence (at 5 J/cm², 6 J/cm², 8.5 J/cm², and 10.5 J/cm² from sample #1 only) sequence of shots. We note that only the first shots at 5 J/cm² on sample #1 are included in the data set for constant fluence. In addition, these experiments have effectively covered a wide range of fluences from ˜2 J/cm² up to ˜13 J/cm² due to the OSL beam contrast and the use of multiple samples (experiments). Because each of the ˜300 sites on a part may see a different fluence on each shot, every site/exposure is treated as an independent experiment. This highly parallel technique has allowed us to amass data sets in excess of 3000 and 4000 entries for constant fluence and ramped fluence experiments, respectively. The results of the cumulative single-shot analysis approach are presented in FIGS. 4A and 4B as the probability of growth as a function of laser fluence (in 1 J/cm² bins, using the local mean fluence for each site) and site size for the two experimental scenarios described above.

FIG. 4A is a plot illustrating cumulative single-shot probability of growth vs. site size vs. laser fluence for damage sites exposed to a nearly constant fluence sequence of shots. FIG. 4B is a plot illustrating cumulative single-shot probability of growth vs. site size vs. laser fluence for damage sites exposed to a ramp-up fluence sequence of shots. The solid lines represent the best fits to the data using logistic curves (Eq. (2)).

Due to the nature of the raster scan initiation method (with the goal of producing a large number of small sites) and the range of fluences illustrated herein (up to ˜13 J/cm²), the largest size bins were sparsely populated, while the smallest sites (up to 30 μm) rarely grew. All data points in FIGS. 4A and 4B represent size/fluence bins with a minimum of 50 observations, therefore the errors on the probability values (not shown) prescribed by Eq. (1) are less than 15%, and often below 10%. Other errors due to fluence and size binning are convoluted in these probability values, but as such errors are only a few percent, the overall limit of the measurement errors is ˜15% or less. Results shown in FIG. 4A illustrate the growth behaviors of small damage sites for the simplest example of laser exposure history where all sites have been exposed for up to 5 shots at nearly identical fluences (all other laser parameters being the same). The next straightforward example of laser exposure history is illustrated in FIG. 4B, where all sites have been exposed to gradually increasing fluences. The latter is true based on the repeatable sample positioning with respect to the laser beam and the reasonably static beam contrast, i.e., the local mean fluence experienced by any damage site closely follows the variation in the average beam fluence for all shots. There are both similarities and differences between the two scenarios presented in FIGS. 4A and 4B and these are discussed next.

First, the general trends that apply to both experiments should be noted. The probability of growth is strongly dependent on site size and fluence, i.e., increasing for larger sites and higher fluences. In particular, size effects dominate the growth behavior of sites with diameters up to 50 μm, i.e., the rate at which the probability increases from 0 to 1 (slope) is very distinct for the first three size bins. To better quantify these size effects, we use a 4-parameter logistic function to fit the probability of growth data vs. fluence for each individual size bin (solid and dashed curves in FIGS. 4A and 4B, respectively). The logistic function depicts a sigmoid curve and is widely used for growth modeling (for example, dose-response in pharmacology/chemistry) as follows:

$$y ( x ) = \frac{{A}_{1} - {A}_{2}}{1 + {( \frac{x}{{x}_{0}} )}^{p}} + {A}_{2} , \qquad ( 2 )$$

where A_{1,2} are initial and final values, x₀ is the center value, and p is the power (shape), respectively. This model is effective in reproducing the shape of the data presented in FIGS. 4A and 4B for all size bins. By definition, the probability takes values from 0 to 1, therefore the first two fitting parameters are fixed for all curves as A₁=0 and A₂=1. As a result, only two parameters are effectively used in fitting the experimental data, x₀ and p. The parameter x₀ is of particular interest as the fluence at which the probability of growth is equal to 0.5, which is equivalent to what is typically meant by 50% growth threshold parameter, φ_{50%} in some literature. The shape parameter relates to the rate of increase (derivative) of the probability of growth vs. fluence.

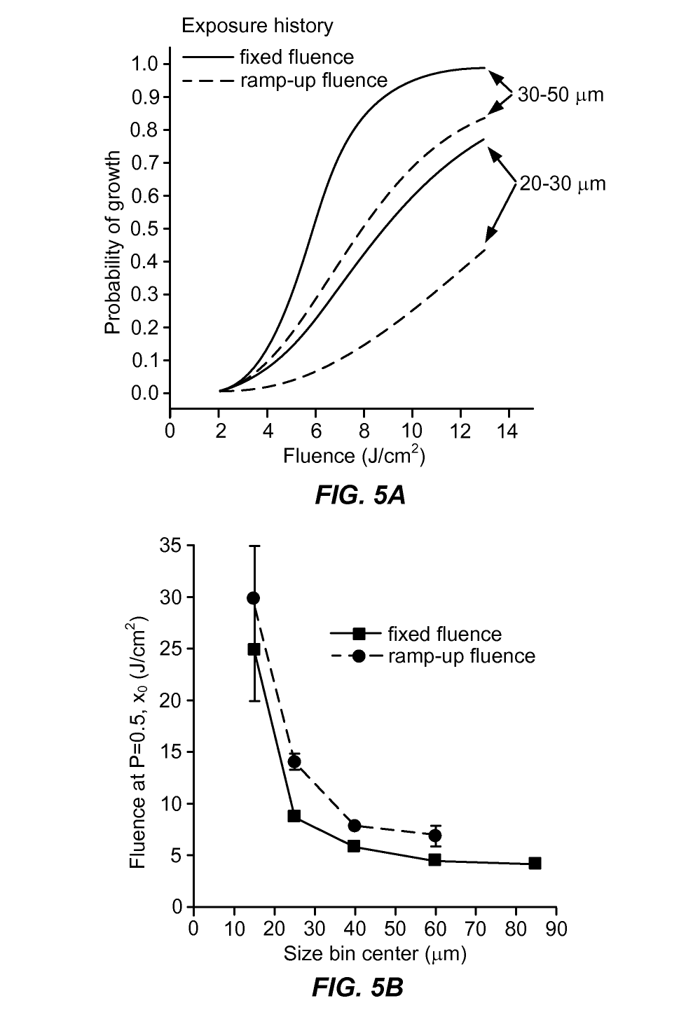

Additionally, is should be noted that the effects of laser exposure history can be clearly seen by comparing the shape of the probability vs. fluence curves for the same size bins from FIGS. 4A and 4B. Specifically, the ramp-up fluence scenario (FIG. 4B) resulted in a systematic decrease in the slope of the sigmoid curves, for all size bins up to 70 μm, compared to those observed from the fixed fluence scenario (FIG. 4A). In other words, there is a “conditioning” effect for small sites manifested as a reduction in their likelihood to grow at higher fluences following pre-exposure to lower fluences. To better illustrate this effect, the logistic fitting curves corresponding to 20-30 μm and 30-50 μm sites from FIGS. 4A and 4B are overlaid in FIG. 5A (solid and dashed lines, respectively).

FIG. 5A is a plot illustrating a comparison of the probability of growth vs. fluence for 20-30 μm and 30-50 μm size bins according to an embodiment of the present invention. FIG. 5B is a plot illustrating a comparison of the fluence at which the probability of growth is equal to 0.5, x₀, vs. damage site size (bin center) for two laser exposure scenarios according to an embodiment of the present invention. In FIG. 5B, the two laser exposure scenarios are fixed fluence (solid lines) and ramp-up fluence (dashed lines), respectively. The logistic curves and fitting parameters are based on the results shown in FIGS. 4A and 4B.

Furthermore, in FIG. 5B, the fluence is plotted at which the probability of growth is equal to 0.5 (x₀ fitting parameter) from all curves in FIGS. 4A and 4B as a function of size bin (the center value) and laser exposure history. The error bars represent the uncertainty associated with the logistic curve fits, which are larger for the extreme size bins. It should be noted that the results in FIG. 5B both retain the ˜5 J/cm²“growth threshold” that has been associated with large sites and are in excellent agreement with our previous growth studies which reported the effect of site size on probability and rate of growth. The trends illustrated in FIG. 5 also demonstrate that the conditioning effect (for damage initiation) known to be present in KDP is also present to a lesser extent in SiO₂ (for damage growth), though the fundamental mechanisms associated with these processes are almost certainly very distinct.

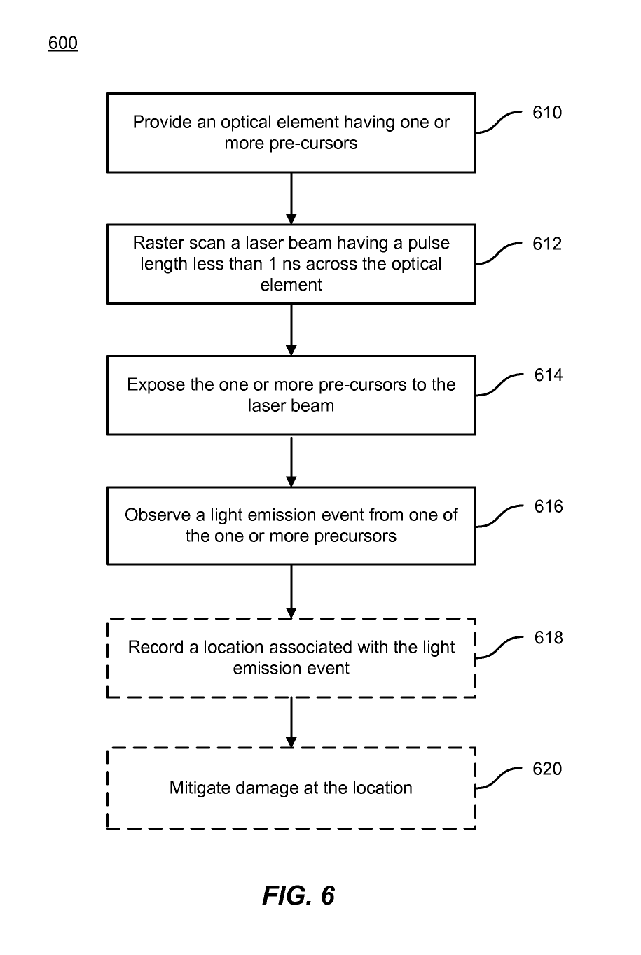

FIG. 6 is a simplified flowchart illustrating a method of processing an optical element according to an embodiment of the present invention. The method 600 includes providing the optical element (610). A surface region of the optical element includes one or more pre-cursors. The method also includes raster scanning a laser beam across the optical element (612). According to embodiments of the present invention, the laser beam includes a plurality of laser pulses, each of the laser pulses being characterized by a pulse length less than 1 ns. As described herein, the use of a picosecond laser enables small pre-cursors to be treated without substantial damage to material surrounding the pre-cursor.

According to embodiments of the present invention the picosecond laser is characterized by a pulse length that ranges between 5 ps and 1 ns, for example, a pulse length between 20 ps and 500 ps. In a particular embodiment, the pulse length is between 100 ns and 300 ns.

The method further includes exposing the one or more pre-cursors to the laser beam (614) and observing a light emission event from one of the one or more pre-cursors (616). Observing a light emission event can include measuring spectral information related to the light emission event. Observing a light emission event can also include imaging the optical element using at least one camera.

According to some embodiments of the present invention, the laser beam is characterized by a lasing wavelength (e.g., 351 nm) and the light emission event is characterized by a wavelength profile different than the lasing wavelength. Under some conditions, the wavelength profile of the light emission event is a harmonic of the lasing wavelength. Under other conditions, the wavelength profile of the light emission event is characterized by a blackbody radiation curve.

In some embodiments, the spectral content of the emission from the one or more pre-cursors is utilized to analyze the efficacy of the damage repair. As an example, during raster scanning of the optical element, passivation could be indicated by the emission being characterized by a blackbody radiation curve, indicating that absorption of the laser pulse by the pre-cursor resulted in generation of an absorption front in the material, which produces the blackbody flash. If no blackbody radiation is observed, then that could be an indicator that absorption in the material was not sufficient to launch the absorption front and that the pre-cursor has not been ablated or removed. Several systems for detecting the spectral content of the emission from the pre-cursor could be used, including two cameras with predetermined wavelength spectral filters, a color camera with multiple channel outputs, a spectrometer, or the like.

In some optional embodiments, the method also includes recording a location associated with the light emission event from the one of the one or more pre-cursors (618) and mitigating damage at the location of the one of the one or more pre-cursors (620). The damage at the location of the one of the one or more pre-cursors can be less than 80 μm in size.

The picosecond laser pulses are preferably characterized by “flat in time” pulse shapes with reduced tails in comparison to conventional pulses. In particular, excimer laser pulses are characterized by long pulse tails. The inventors have determined that the long pulse tail associated with excimer lasers produces fracture at the precursor site, adversely impacting mitigation efforts. Thus, top hat shaped pulses are utilized in some embodiments, treating the precursor sites and terminating the delivery of optical energy in a rapid manner. As an example, the pulse shape has a pulse length less than 1 ns FWHM and a fall time less than 80 ps. The short tails associated with embodiments of the transfer enough energy to the precursor site to treat the precursor, but do not deposit significant energy into the material surrounding the precursor site, which is a phenomenon associated with long pulse tails.

Considering the fluences associated with precursor treatment, the fluence ranges from about 1 J/cm² to about 1 J/cm² for a 350 ps pulse and from about 0.5 J/cm² to about 1 J/cm² for a 100 ps pulse.

Embodiments of the present invention utilize laser pulses with short durations in comparison to conventional laser repair pulses, producing a small amount of damage that is localized around the precursor site, enabling passivation of precursor sites, converting them into damage sites that are benign with respect to future pulses passing through the optical element. By identifying these benign damage sites, the method may be extended to passivation using a laser other than the picosecond laser. One of ordinary skill in the art would recognize many variations, modifications, and alternatives.

It should be appreciated that the specific steps illustrated in FIG. 6 provide a particular method of processing an optical element according to an embodiment of the present invention. Other sequences of steps may also be performed according to alternative embodiments. For example, alternative embodiments of the present invention may perform the steps outlined above in a different order. Moreover, the individual steps illustrated in FIG. 6 may include multiple sub-steps that may be performed in various sequences as appropriate to the individual step. Furthermore, additional steps may be added or removed depending on the particular applications. One of ordinary skill in the art would recognize many variations, modifications, and alternatives.

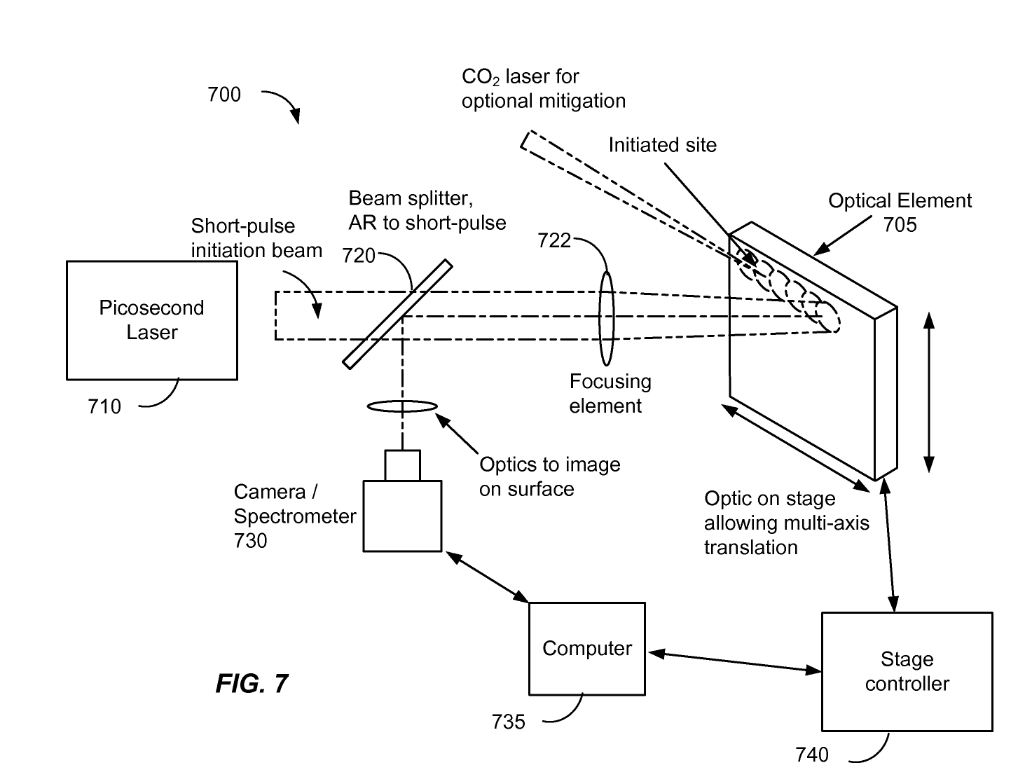

FIG. 7 is a simplified schematic diagram of a system for processing optical elements according to an embodiment of the present invention. The system 700 includes a picosecond laser 710 operable to provide pulses less than or equal to 1 ns in pulse length or duration. In various embodiments, the pulse length varies from about 5 ps to about 1 ns, for example, between 20 ps and 500 ps or between 100 ns and 300 ns. Optical elements, which may include, but are not limited to a beam splitter 720 and one or more lenses, mirrors, or other suitable focusing elements 722, are utilized to direct the short-pulse initiation beam from the picosecond laser 710 to impinge on a predetermined focal spot on the optical element 705.

In the embodiment illustrated in FIG. 7, an additional laser (e.g., a CO₂ laser or other suitable laser) is provided to provide for optional mitigation of precursor and/or defect sites.

In an embodiment, the beam from the picosecond laser 710 is raster scanned over the optical element and the camera 730 is used to record an image of the area being raster scanned. The PC can record the location that is being imaged. The beam can be raster scanned by moving the beam (e.g., with controllable mirrors) or by moving/rotating the optical element 705 on a stage as illustrated in FIG. 7. Using the camera, emission from the precursor site can be detected while at the same time, the emission location is recorded. Thus, embodiments of the present invention can log or record locations where damage is detected. It should be noted that recording the emissions can include obtaining a spectral recording as a function of position. As discussed above, this spectral information can be used to determine if the precursor at a particular location has been passivated.

It is also understood that the examples and embodiments described herein are for illustrative purposes only and that various modifications or changes in light thereof will be suggested to persons skilled in the art and are to be included within the spirit and purview of this application and scope of the appended claims.

What is claimed is:

1. A method of processing an optical element, the method comprising:
providing the optical element, wherein a surface region of the optical element includes one or more pre-cursors;
raster scanning a laser beam across the optical element, wherein the laser beam comprises a plurality of laser pulses, each of the laser pulses being characterized by a pulse length less than 1 ns;
exposing the one or more pre-cursors to the laser beam; and
observing a light emission event from one of the one or more pre-cursors.

2. The method of claim 1 further comprising:
recording a location associated with the light emission event from the one of the one or more pre-cursors; and
mitigating damage at the location of the one of the one or more pre-cursors.

3. The method of claim 2 wherein the damage at the location of the one of the one or more pre-cursors is less than 80 μm in size.

4. The method of claim 1 wherein the pulse length is between 5 ps and 1 ns.

5. The method of claim 4 wherein the pulse length is between 20 ps and 500 ps.

6. The method of claim 5 wherein the pulse length is between 100 ns and 300 ns.

7. The method of claim 1 wherein the laser beam is characterized by a lasing wavelength and the light emission event is characterized by a wavelength profile different than the lasing wavelength.

8. The method of claim 7 wherein the wavelength profile of the light emission event is a harmonic of the lasing wavelength.

9. The method of claim 7 wherein the wavelength profile of the light emission event is characterized by a blackbody radiation curve.

10. The method of claim 1 wherein observing a light emission event comprises measuring spectral information related to the light emission event.

11. The method of claim 1 wherein observing a light emission event comprises imaging the optical element using at least one camera.

12. A system for processing an optical element, the system comprising:
a stage operable to support the optical element, wherein a surface region of the optical element includes one or more pre-cursors;
a picosecond laser operable to provide a laser beam including a plurality of laser pulses, each of the laser pulses being characterized by a pulse length less than 1 ns;
a control system coupled to at least one of the stage or the picosecond laser and operable to raster scan the laser beam across the optical element; and
an optical detector operable to observe a light emission event from one of the one or more pre-cursors.

13. The system of claim 12 further comprising a computer operable to record a location associated with the light emission event from the one of the one or more pre-cursors.

14. The system of claim 12 wherein the pulse length is between 5 ps and 1 ns.

15. The system of claim 14 wherein the pulse length is between 20 ps and 500 ps.

16. The system of claim 15 wherein the pulse length is between 100 ns and 300 ns.

17. The system of claim 12 wherein the optical detector comprises a camera.

18. The system of claim 17 wherein the optical detector is operable to obtain spectral information related to the light emission event.
